(19) United States
(12) Patent Application Publication
(10) Pub. No.: US 2025/0218651 A1
(43) Pub. Date: Jul. 3, 2025

(54) LAMINATED COIL COMPONENT

(71) Applicant: Murata Manufacturing Co., Ltd., Kyoto-fu (JP)

(72) Inventors: Reiji OZAWA, Nagaokakyo-shi (JP); Maasa NAKANO, Nagaokakyo-shi (JP)

(73) Assignee: Murata Manufacturing Co., Ltd., Kyoto-fu (JP)

(21) Appl. No.: 19/002,610

(22) Filed: Dec. 26, 2024

(30) Foreign Application Priority Data
Dec. 28, 2023 (JP) 2023-222749

(51) Int. Cl. H01F 27/29; H01F 27/28; H01F 27/32

(52) U.S. Cl. CPC H01F 27/29; H01F 27/2804; H01F 27/323; H01F 2027/2809

(57) ABSTRACT

A laminated coil component includes a multilayer body including laminated insulation layers and a coil inside; and first and second outer electrodes electrically connected to the coil. The coil is composed of coil conductors laminated together with the insulation layers and electrically connected to one another. The multilayer body has first and second end surfaces opposed to each other in a longitudinal direction, a first and second main surfaces opposed to each other in a height direction orthogonal to the longitudinal direction, and first and second side surfaces opposed to each other in a width direction orthogonal to the longitudinal direction and the height direction. The first outer electrode covers at least part of the first end surface, the second outer electrode covers at least part of the second end surface, and a coil axis of the coil is parallel to the first main surface.

### CROSS-REFERENCE TO RELATED APPLICATION

This application claims benefit of priority to Japanese Patent Application No. 2023-222749, filed Dec. 28, 2023, the entire content of which is incorporated herein by reference.

### BACKGROUND

### Technical Field

The present disclosure relates to a laminated coil component.

### Background Art

As one of the methods to reduce the direct current resistance of a laminated coil component, a method in which outer electrode terminals are formed to be thick is known.

For example, Japanese Unexamined Patent Application Publication No. 2017-216290 discloses a laminated coil component including an element body including a coil inside, and outer electrodes each including an underlying metal layer located on a surface of the element body and a conductive resin layer formed so as to cover the underlying metal layer. The positions where connection conductors are exposed differ from the maximum thickness positions of the conductive resin layers, so that the direct current resistance of the laminated coil component is reduced.

### SUMMARY

In order to support larger current demand for laminated coil components, reducing heat generation is required. To reduce heat generation in a laminated coil component, for example, reducing the current density is effective. The laminated coil component described in Japanese Unexamined Patent Application Publication No. 2017-216290 enables the direct current resistance to be reduced (the current density to be reduced). However, in the method described in Japanese Unexamined Patent Application Publication No. 2017-216290, the laminated coil component has such a shape that parts of the outer electrodes bulge conspicuously, which increases the volume. Hence, it has a concern that the mounting density can be low.

Accordingly, the present disclosure provides a laminated coil component having a lower current density without changing the outer appearance shape of the chip conspicuously.

A laminated coil component of the present disclosure includes a multilayer body including a plurality of laminated insulation layers and including a coil inside; and first and second outer electrodes electrically connected to the coil. The coil is composed of a plurality of coil conductors laminated together with the insulation layers and electrically connected to one another. The multilayer body has a first end surface and a second end surface opposed to each other in a longitudinal direction, a first main surface and a second main surface opposed to each other in a height direction orthogonal to the longitudinal direction, and a first side surface and a second side surface opposed to each other in a width direction orthogonal to the longitudinal direction and the height direction. The first outer electrode covers at least part of the first end surface, and the second outer electrode covers at least part of the second end surface. A coil axis of the coil is parallel to the first main surface. The first end surface has a first depression having a deepest portion on an inner side of circling-shape portions of the coil in transparent view of the multilayer body in the longitudinal direction, and the first outer electrode covers at least part of the first depression.

With the present disclosure, it is possible to provide a laminated coil component having a lower current density without changing the outer appearance shape of the chip conspicuously.

### BRIEF DESCRIPTION OF THE DRAWINGS

FIG. 1 is a schematic perspective view of an example of a laminated coil component of the present disclosure;

FIG. 2 is a schematic exploded perspective view of an example of a multilayer body included in the laminated coil component in illustrated in FIG. 1;

FIG. 3 is a transparent side view of the multilayer body included in the laminated coil component illustrated in FIG. 1, schematically illustrating an example of the internal structure;

FIG. 4 is a cross-sectional view of the laminated coil component illustrated in FIG. 1, schematically illustrating an example of the cross section taken along line segment A1-A1;

FIG. 5 is a perspective view of the multilayer body included in the laminated coil component illustrated in FIG. 1, from a first end surface side;

FIG. 6 is a schematic transparent view of part of the internal structure of the multilayer body illustrated in FIG. 5, from the first end surface side;

FIG. 7 is a diagram illustrating the simulation results of the current density of outer electrodes for the case in which each of a first end surface and a second end surface has a depression; and

FIG. 8 is a diagram illustrating the simulation results of the current density of the outer electrodes for the case in which each of the first end surface and the second end surface does not have a depression.

### DETAILED DESCRIPTION

Hereinafter, a laminated coil component of the present disclosure will be described. The present disclosure is not limited to the following configurations, which may be changed as appropriate within a range not departing from the spirit of the present disclosure. Combinations of two or more individual preferred configurations described in the following are also included in the present disclosure.

The drawings described in the following are schematic, and hence, the dimensions, the scale of the ratio of longitudinal dimensions and lateral dimensions, and the like sometimes differ from those of the actual product. In the figures, the same or corresponding portions are denoted by the same symbols. In the figures, the same elements are denoted by the same symbols, and repetitive description thereof is omitted.

In the present specification, the terms indicating the relationships of components (for example, “parallel”, “orthogonal”, and the like) and the terms indicating the shapes of components not only denote literal configurations in a strict sense but also include substantially equivalent ranges, for example, ranges including differences of about several percent.

Each embodiment in the following is to show an example, and hence it goes without saying that constituents shown in different embodiments can be partially replaced or combined with one another. In a second embodiment and after, description of the items common to those of a first embodiment will be omitted, and only different points will be described. In particular, the same or similar operational advantages by the same or similar configurations will not be referred to in each embodiment.

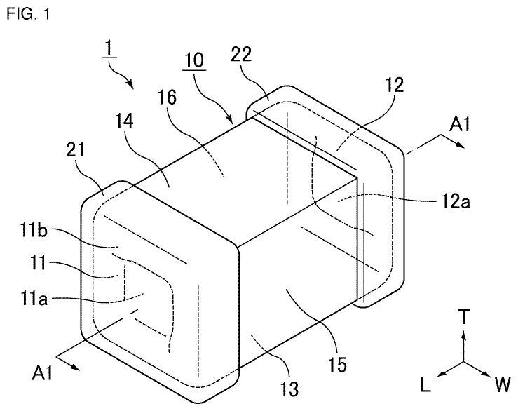

FIG. 1 is a schematic perspective view of an example of a laminated coil component of the present disclosure. The laminated coil component 1 illustrated in FIG. 1 includes a multilayer body (element body) 10 and first and second outer electrodes 21 and 22 provided on outer surfaces of the multilayer body 10. The multilayer body 10 has a rectangular parallelepiped shape having six surfaces. Although the configuration of the multilayer body 10 will be described later, the multilayer body 10 includes a plurality of insulation layers and a plurality of coil conductors laminated in the lamination direction and thus includes a coil inside. Each of the first outer electrode 21 and the second outer electrode 22 is electrically connected to the coil.

In the laminated coil component and the multilayer body in the present specification, the longitudinal direction, the height direction, and the width direction are defined as the L direction, the T direction, and the W direction in FIG. 1. The longitudinal direction L, the height direction T, and the width direction W are orthogonal to one another. The longitudinal direction L is parallel to the lamination direction.

As illustrated in FIG. 1, the multilayer body 10 has a first end surface 11 and a second end surface 12 opposed to each other in the longitudinal direction L, a first main surface 13 and a second main surface 14 opposed to each other in the height direction T orthogonal to the longitudinal direction L, and a first side surface 15 and a second side surface 16 opposed to each other in the width direction W orthogonal to the longitudinal direction L and the height direction T.

Although not illustrated in FIG. 1, it is preferable that the corners and the ridge lines of the multilayer body 10 be rounded. A corner is a portion at which three surfaces of the multilayer body intersect one another, and a ridge line is a portion on which two surfaces of the multilayer body intersect each other.

The first end surface 11 of the multilayer body 10 has a first depression 11a. The second end surface 12 of the multilayer body 10 also has a second depression 12a.

For example, as illustrated in FIG. 1, the first outer electrode 21 covers all of the first end surface 11 of the multilayer body 10 and extends from the first end surface 11 to cover part of the first main surface 13, part of the second main surface 14, part of the first side surface 15, and part of the second side surface 16. In the case in which the first outer electrode 21 covers all of the first depression 11a, whether the first end surface 11 of the multilayer body 10 has a first depression 11a cannot be checked from the outer appearance shape of the first outer electrode 21 in some cases. However, whether a first depression is formed in the first end surface of a multilayer body can be checked by cutting the laminated coil component in the coil axis direction and exposing a cross section.

For example, as illustrated in FIG. 1, the second outer electrode 22 covers all of the second end surface 12 of the multilayer body 10 and extends from the second end surface 12 to cover part of the first main surface 13, part of the second main surface 14, part of the first side surface 15, and part of the second side surface 16. In the case in which the second outer electrode 22 covers all of the second depression 12a, whether the second end surface 12 of the multilayer body 10 has a second depression 12a cannot be checked from the outer appearance shape of second outer electrode 22 in some cases. However, whether a second depression is formed in the second end surface of a multilayer body can be checked by cutting the laminated coil component in the coil axis direction and exposing a cross section.

Thus, when the laminated coil component 1 having the first outer electrode 21 and the second outer electrode 22 is mounted on a board, one of the first main surface 13, the second main surface 14, the first side surface 15, and the second side surface 16 of the multilayer body 10 serves as the mounting surface.

Hence, the first outer electrode 21 needs only to extend over at least part of the first end surface 11 of the multilayer body 10 and the mounting surface of the multilayer body 10.

Similarly, the second outer electrode 22 needs only to extend over at least part of the second end surface 12 of the multilayer body 10 and the mounting surface of the multilayer body 10.

Each of the first outer electrode 21 and the second outer electrode 22 may have a single-layer structure or a multi-layer structure.

In the case in which each of the first outer electrode 21 and the second outer electrode 22 has a single-layer structure, examples of the constituent material of each outer electrode include Ag, Au, Cu, Pd, Ni, Al, and alloys containing at least one of these metals.

In the case in which each of the first outer electrode 21 and the second outer electrode 22 has a multi-layer structure, each outer electrode may include, for example, a base electrode layer containing Ag, a Ni film, and a Sn film in this order from the surface of the multilayer body 10.

Although the size of the laminated coil component of the present disclosure is not particularly limited, it is preferable that the size be larger than or equal to 1608 specified in JIS C 5101-21 (2021) (in which the symbol M indicating that the dimensions are based on metric units is omitted).

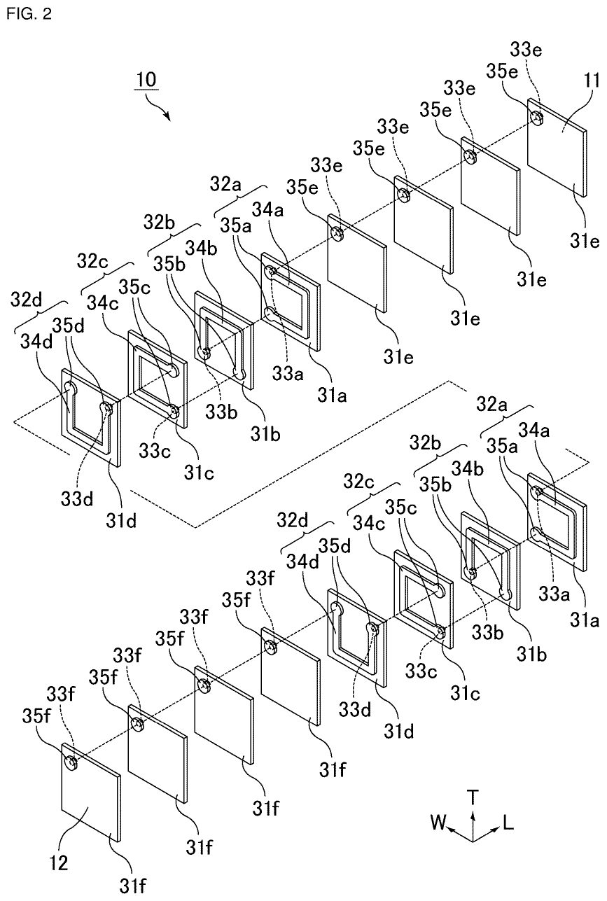

FIG. 2 is a schematic exploded perspective view of an example of the multilayer body included in the laminated coil component illustrated in FIG. 1.

As illustrated in FIG. 2, the multilayer body 10 includes a plurality of insulation layers 31a, 31b, 31c, 31d, 31e, and 31f laminated in the lamination direction (in this case, the longitudinal direction L) from the first end surface 11 toward the second end surface 12 of the multilayer body 10. Hereinafter, the insulation layers 31a, 31b, 31c, 31d, 31e, and 31f are also collectively referred to as the insulation layers 31.

In the present specification, the direction in which the plurality of insulation layers included in the multilayer body are laminated is referred to as the lamination direction.

In FIG. 2, the insulation layers 31e are located on the lower side in the lamination direction (on the first end surface 11 side of the multilayer body 10), and the insulation layers 31f are located on the upper side in the lamination direction (on the second end surface 12 side of the multilayer body 10).

Examples of the constituent material of each insulation layer 31 include magnetic materials such as ferrite materials.

The insulation layers 31a, 31b, 31c, and 31d are provided with coil conductors 32a, 32b, 32c, and 32d and via conductors 33a, 33b, 33c, and 33d, respectively. The insulation layer 31e is provided with a via conductor 33e and a pad 35e. The insulation layer 31f is provided with a via conductor 33f and a pad 35f. The number of insulation layers 31e may be one or two or more. Similarly, the number of insulation layers 31f may be one or two or more. Hereinafter, the coil conductors 32a, 32b, 32c, and 32d are also collectively referred to as the coil conductors 32.

The coil conductors 32a, 32b, 32c, and 32d are provided on main surfaces of the insulation layers 31a, 31b, 31c, and 31d, respectively, and are laminated together with the insulation layers 31a, 31b, 31c, 31d, 31e, and 31f. In FIG. 2, each coil conductor 32 has a shape of ¾ turn, and the four insulation layers 31, which are the insulation layers 31a, 31b, 31c, and 31d arranged in this order, are repeatedly laminated as one unit (corresponding to three turns).

The coil conductors 32a, 32b, 32c, and 32d respectively include circling portions 34a, 34b, 34c, and 34d, each having an annular shape in which one portion is missing and a gap is present, and pads 35a, 35b, 35c, and 35d. The pads 35a, 35b, 35c, and 35d are located at both end portions of the circling portions 34a, 34b, 34c, and 34d, respectively. Hereinafter, the circling portions 34a, 34b, 34c, and 34d are also collectively referred to as the circling portions 34.

The via conductors 33a, 33b, 33c, 33d, 33e, and 33f pass through the insulation layers 31a, 31b, 31c, 31d, 31e, and 31f, respectively, in the lamination direction. Hereinafter, the via conductors 33a, 33b, 33c, 33d, 33e, and 33f are also collectively referred to as the via conductors 33.

The pads 35e and 35f are provided directly on the via conductors 33e and 33f, respectively. It is preferable that the pads 35a, 35b, 35c, 35d, 35e, and 35f be a little larger than the line widths of the circling portions 34a, 34b, 34c, and 34d. Hereinafter, the pads 35a, 35b, 35c, 35d, 35e, and 35f are also collectively referred to as the pads 35.

Examples of the constituent material of each coil conductor 32, including the circling portion 34 and the pad 35, and each via conductor 33 include Ag, Au, Cu, Pd, Ni, Al, and alloys containing at least one of these metals.

The plurality of insulation layers 31a, 31b, 31c, 31d, 31e, and 31f configured as described above are laminated in the lamination direction. This forms the multilayer body 10, and the plurality of coil conductors 32a, 32b, 32c, and 32d are electrically connected to one another with the via conductors 33a, 33b, 33c, and 33d interposed therebetween. Thus, a coil in the form of a solenoid having a coil axis parallel to the lamination direction is formed in the multilayer body 10.

The via conductors 33e and the pads 35e serve as a first connecting extension conductor in the multilayer body 10, part of which is exposed on the first end surface 11 of the multilayer body 10. In other words, the first connecting extension conductor includes the via conductors 33e and the pads 35e. As described later, the first connecting extension conductor connects, in the multilayer body 10, the first outer electrode 21 and the coil conductor 32a facing the first outer electrode 21.

The via conductors 33f and the pads 35f serve as a second connecting extension conductor in the multilayer body 10, part of which is exposed on the second end surface 12 of the multilayer body 10. In other words, the second connecting extension conductor includes the via conductors 33f and the pads 35f. As described later, the second connecting extension conductor connects, in the multilayer body 10, the second outer electrode 22 and the coil conductor 32d facing the second outer electrode 22.

It is preferable that the coil conductors 32 overlap one another when viewed in the lamination direction (the longitudinal direction L). When viewed in the lamination direction, the coil may have a shape composed of straight lines as illustrated in FIG. 2 (for example, a polygonal shape such as a rectangle), may have a shape composed of curved lines (for example, a circular shape), or may have a shape composed of straight lines and curved lines.

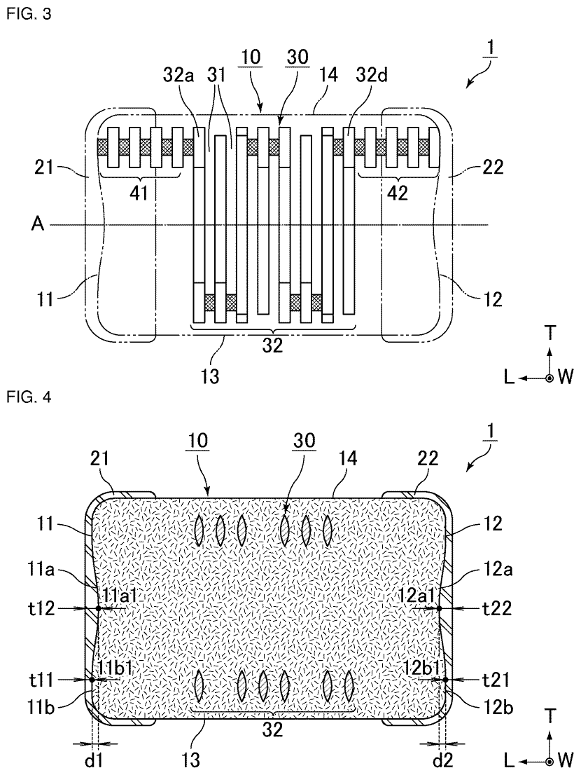

FIG. 3 is a transparent side view of the multilayer body included in the laminated coil component illustrated in FIG. 1, schematically illustrating an example of the internal structure.

As illustrated in FIG. 3, the plurality of insulation layers 31 are laminated in the longitudinal direction L in the laminated coil component 1, and hence, the longitudinal direction L is the lamination direction. The lamination direction of the multilayer body 10 and the coil axis A of the coil 30 are parallel to the mounting surface, which is one of the first main surface 13, the second main surface 14, the first side surface 15, and the second side surface 16, for example, the first main surface 13.

As illustrated in FIG. 3, no boundary is actually seen between adjoining insulation layers 31.

The first connecting extension conductor 41 extends in the multilayer body 10 in the lamination direction to connect the first outer electrode 21 located on the first end surface 11 to the coil conductor 32a facing the first outer electrode 21 in a straight line. Similarly, the second connecting extension conductor 42 extends in the multilayer body 10 in the lamination direction to connect the second outer electrode 22 located on the second end surface 12 to the coil conductor 32d facing the second outer electrode 22 in a straight line.

Although it is preferable that the via conductors included in the connecting extension conductor overlap one another when viewed in the lamination direction (the longitudinal direction L), the via conductors included in the connecting extension conductor need not be aligned strictly in a straight line.

Although FIGS. 2 and 3 illustrate an example in which the number of laminated coil conductors 32 for forming three turns of the coil 30 is four, in other words, an example in which the repeated shape is a three-quarters turn shape, the number of laminated coil conductors 32 for forming one turn of the coil 30 is not particularly limited. For example, the number of laminated coil conductors 32 for forming one turn of the coil 30 may be two, in other words, the repeated shape may be a half turn shape.

Although the number of laminated coil conductors 32, in other words, the total number of laminated coil conductors 32 included in the multilayer body 10 is not particularly limited, it should preferably be 30 or more and 120 or less (i.e., from 30 to 120).

FIG. 4 is a cross-sectional view of the laminated coil component illustrated in FIG. 1, schematically illustrating an example of the cross section taken along line segment A1-A1.

When a cross section in a direction perpendicular to the extending direction of the coil conductor 32 is viewed as illustrated in FIG. 4, the cross-sectional shape of the coil conductor 32 is a compressed shape (an elongated shape), the longitudinal direction of which is orthogonal to the lamination direction (the longitudinal direction L). Although the cross-sectional shape of the coil conductor 32 is an elliptical shape the major axis of which is orthogonal to the lamination direction in the example illustrated in FIG. 4, the cross-sectional shape of the coil conductor 32 is not particularly limited. For example, the cross-sectional shape of the coil conductor 32 may be a rectangular shape in which the lengths of the pair of sides facing each other in the lamination direction are the same, a trapezoidal shape in which the lengths of the pair of sides facing each other in the lamination direction are different, or other shapes.

The first end surface 11 of the multilayer body 10 illustrated in FIG. 4 has the first depression 11a. The first depression 11a is a macroscopic depression formed by the portion overlapping the circling-shape portions of the coil in transparent view of the multilayer body 10 in the longitudinal direction L bulging relatively and the portion on the inner side of the bulging portion being depressed relatively, in the first end surface 11 of the multilayer body 10. Hence, the first depression differs from fine irregularities formed in the surfaces of the multilayer body. The same is true of the second depression described later.

The first depression 11a formed in the first end surface 11 has the deepest portion 11a1 on the inner side of the circling-shape portions of the coil in transparent view of the multilayer body 10 in the longitudinal direction L. The first end surface 11 of the multilayer body 10 has a first annular protrusion 11b protruding annularly so as to overlap the circling-shape portions of the coil in the direction opposite to the depth direction of the first depression 11a, in other words, outward of the multilayer body 10. The depth d₁ of the deepest portion 11a1 of the first depression 11a is the length in the longitudinal direction L from the deepest portion 11a1 of the first depression 11a to the crest 11b1 of the first annular protrusion 11b which is the most bulging portion of the first end surface 11.

The depth of the deepest portion of the first depression in the first end surface is measured as follows. A multilayer body is ground from a side surface (LT surface) of the multilayer body to the center in the width direction W to expose an LT cross section. A cross-sectional image of the cross section is obtained by using a digital microscope or the like. The difference in dimension between the lowest portion (the most depressed portion) in the insulation layer and the highest portion (the most bulging portion, which corresponds to the crest of the first annular protrusion) in the longitudinal direction L is measured by using a parallel-dimension measurement instrument or the like.

Since the first annular protrusion 11b extends annularly so as to correspond to the circling-shape portions of the coil, the crest 11b1 of the first annular protrusion 11b is not one place of the first annular protrusion bulging most but a ridge line located annularly at the positions overlapping the circling-shape portions of the coil. The entire region surrounded by the crest 11b1 of this first annular protrusion 11b corresponds to the first depression 11a.

Since the first annular protrusion is located so as to overlap the circling-shape portions of the coil, and the deepest portion of the first depression is located on the inner side of the circling-shape portions of the coil, it can be said that the first depression is located on the inner side of the first annular protrusion in transparent view of the multilayer body in the longitudinal direction L.

The first outer electrode 21 is formed so as to cover the deepest portion 11a1 of the first depression 11a and the crest 11b1 of the first annular protrusion 11b.

Although the first outer electrode 21 illustrated in FIG. 4 covers all of the first end surface 11 of the multilayer body 10 and extends from the first end surface 11 to cover parts of the first main surface 13, the second main surface 14, the first side surface 15, and the second side surface 16, the first outer electrode in the laminated coil component of the present disclosure needs only to cover at least part of the first depression in the first end surface and part of the surface serving as the mounting surface. For example, the first outer electrode may also be an L-shaped electrode that covers part of the first end surface and extends from the first end surface to cover the surface serving as the mounting surface (for example, the second main surface). Alternatively, the first outer electrode may also be a beveled electrode that covers part of the first end surface, extends from the first end surface to cover part of the surface serving as the mounting surface (for example, the second main surface), and extends from the first end surface and the mounting surface (for example, the second main surface) to cover parts of the first side surface and the second side surface.

The first outer electrode and the second outer electrode may be resin electrode layers formed by applying a conductive paste such as a paste containing Ag and glass frit to the first end surface and the second end surface of the multilayer body, and sintering the applied conductive paste. In the case in which the first outer electrode and the second outer electrode are resin electrode layers, even if a board after mounting is warped, the stress transmitted from the board is likely to be relieved, and hence, resin electrode layers have excellent connection reliability.

In the case in which the first outer electrode 21 covers at least part of the first depression 11a, it is possible to increase the thickness of the first outer electrode 21 by the depth of the first depression 11a while preventing the first outer electrode 21 from bulging outward. Thus, it is possible to reduce the current density without changing the outer appearance shape of the chip significantly.

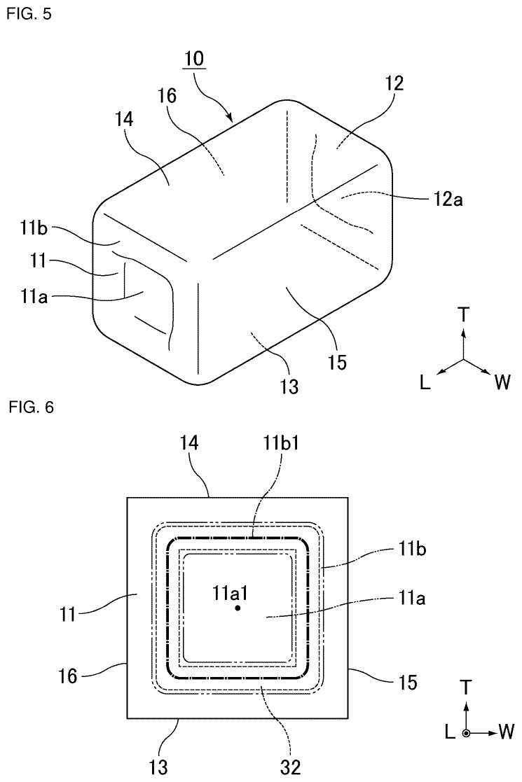

The first depression formed in the first end surface of the multilayer body will be described with reference to FIGS. 5 and 6. FIG. 5 is a perspective view of the multilayer body included in the laminated coil component illustrated in FIG. 1, from the first end surface side. FIG. 6 is a schematic transparent view of part of the internal structure of the multilayer body illustrated in FIG. 5, from the first end surface side. As illustrated in FIGS. 5 and 6, the first end surface 11 of the multilayer body 10 has the first depression 11a. As illustrated in FIG. 6, the first depression 11a has the deepest portion Hal on the inner side of the circling-shape portions of the coil. Note that portions of the first depression 11a other than the deepest portion may overlap the circling-shape portions of the coil. As illustrated in FIGS. 5 and 6, the first end surface 11 of the multilayer body has the first annular protrusion 11b. As illustrated in FIG. 6, the first annular protrusion 11b has an annular shape and is located so as to overlap the circling-shape portions of the coil. When the first annular protrusion 11b is scanned from the inner side to the outer side of the circling-shape portions of the coil, the place the distance between which and the deepest portion 11a1 of the first depression 11a in the longitudinal direction L is longest is defined as the crest 11b1 of the first annular protrusion 11b. The crest 11b1 of the first annular protrusion 11b has an annular shape at positions overlapping the circling-shape portions of the coil.

The first depression 11a is a macroscopic depression formed by the portion overlapping the circling-shape portions of the coil in transparent view of the multilayer body 10 in the longitudinal direction L bulging relatively and the portion on the inner side of the bulging portion being depressed relatively, in the first end surface 11 of the multilayer body 10. Hence, the first depression differs from fine irregularities formed in the surfaces of the multilayer body. The same is true of the second depression described later.

It is preferable that the maximum thickness of the first outer electrode be larger than the depth of the deepest portion of the first depression. In the laminated coil component 1 illustrated in FIG. 4, the maximum thickness (the length indicated by the double arrow t₁₂ in FIG. 4) of the first outer electrode 21 is larger than the depth d₁ of the deepest portion 11a1 of the first depression 11a. Note that the thickness of the portion of the first outer electrode covering the deepest portion of the first depression may be the maximum thickness of the first outer electrode. In the laminated coil component 1 illustrated in FIG. 4, the thickness t₁₂ of the portion of the first outer electrode 21 covering the deepest portion 11a1 of the first depression 11a is the maximum thickness of the first outer electrode 21.

It is preferable that the first outer electrode cover the deepest portion of the first depression. In the laminated coil component 1 illustrated in FIG. 4, the first outer electrode 21 covers the deepest portion 11a1 of the first depression 11a in the first end surface 11 of the multilayer body 10. In the case in which the first outer electrode covers the deepest portion of the first depression, it is possible to maximize the thickness of the first outer electrode without changing the outer shape of the chip significantly.

It is preferable that the first end surface have the first annular protrusion protruding annularly and that the first annular protrusion overlap the circling-shape portions of the coil in transparent view of the multilayer body in the longitudinal direction. In this case, it is preferable that the first outer electrode cover at least part of the crest of the first annular protrusion in the first end surface. Also in this case, it is preferable that the thickness of the portion of the first outer electrode covering the deepest portion of the first depression be larger than the thickness of the portion of the first outer electrode covering at least part of the crest of the first annular protrusion. In the case in which the thickness of the portion of the first outer electrode covering the deepest portion of the first depression is larger than the thickness of the portion of the first outer electrode covering the crest of the first annular protrusion, the first outer electrode is formed so as to fill the first depression, increasing the effect of reducing the current density.

In the laminated coil component 1 illustrated in FIG. 4, the first end surface 11 of the multilayer body 10 has the first annular protrusion 11b, which is the portion of the first end surface 11 protruding annularly, at the positions overlapping the circling-shape portions of the coil (the coil conductors 32) in the longitudinal direction L. The first outer electrode 21 covers all of the crest 11b1 of the first annular protrusion 11b. The thickness t₁₂ of the portion of the first outer electrode 21 covering the deepest portion 11a1 of the first depression 11a is larger than the thickness t₁₁ of the portion of the first outer electrode 21 covering the crest 11b1 of the first annular protrusion 11b.

It is preferable that the thickest portion of the first outer electrode be located on the inner side of the circling-shape portions of the coil, in other words, at the position overlapping the first depression in transparent view of the multilayer body in the longitudinal direction. In the laminated coil component 1 illustrated in FIG. 4, the position at which the first outer electrode 21 is thickest is at the position overlapping the deepest portion 11a1 of the first depression 11a.

Although the surface of the first outer electrode 21 covering the first end surface 11 of the multilayer body 10 does not have a depression in the laminated coil component 1 illustrated in FIG. 4, the first outer electrode 21 covering the first end surface 11 of the multilayer body may have a shape slightly depressed inward according to the first depression 11a or conversely, slightly bulging outward within a range not changing the outer appearance shape of the chip conspicuously. For example, the first outer electrode 21 covering the first end surface 11 of the multilayer body may have a depression having a similar shape to the first depression of the first end surface 11 and shallower than the first depression. For example, this situation occurs in the case in which the shape of the first outer electrode covering the first end surface of the multilayer body conforms to the shape of the first end surface 11 to some extent.

It is preferable that the depth of the deepest portion of the first depression be 30 μm or more and 50 μm or less (i.e., from 30 μm to 50 μm). In the laminated coil component 1 illustrated in FIG. 4, it is preferable that the depth d₁ of the deepest portion 11a1 of the first depression 11a be 30 μm or more and 50 μm or less (i.e., from 30 μm to 50 μm). In the case in which the depth of the deepest portion of the first depression is within the range mentioned above, it is possible to prevent a bubble from being trapped when the outer electrodes are formed by a dip method, reducing defects in forming the outer electrode.

It is preferable that the thickness of the portion of the first outer electrode covering the deepest portion of the first depression be 30 μm or more and 100 μm or less (i.e., from m to 100 μm). As for the thickness of the first outer electrode, it is preferable that the maximum thickness of the portion of the outer electrode not covering the first depression be 20% or more and 100% or less (i.e., from 20% to 100%) of the thickness of the portion of the outer electrode covering the deepest portion of the first depression.

The second end surface and the second outer electrode of the multilayer body may also have the structure the same as or similar to that of the first end surface and the first outer electrode of the multilayer body described above.

The second end surface of the multilayer body may have the second depression having the deepest portion on the inner side of the circling-shape portions of the coil in transparent view of the multilayer body in the longitudinal direction. The second end surface 12 of the multilayer body 10 illustrated in FIG. 4 has the second depression 12a. The second depression 12a formed in the second end surface 12 has the deepest portion 12a1 on the inner side of the circling-shape portions of the coil in transparent view of the multilayer body 10 in the longitudinal direction L.

The second end surface 12 of the multilayer body 10 illustrated in FIG. 4 has a second annular protrusion 12b protruding annularly so as to overlap the circling-shape portions of the coil in the direction opposite to the depth direction of the second depression 12a, in other words, outward of the multilayer body 10. When the second annular protrusion 12b is scanned from the inner side to the outer side of the circling-shape portions of the coil, the place the distance between which and the second depression 12a in the longitudinal direction is longest is defined as the crest 12b1 of the second annular protrusion 12b. Specifically, the crest 12b1 of the second annular protrusion 12b has an annular shape at positions overlapping the circling-shape portions of the coil. Hence, the length from the deepest portion 12a1 of the second depression 12a to the crest 12b1 of the second annular protrusion 12b in the longitudinal direction L is the depth d₂ of the deepest portion 12a1 of the second depression 12a.

The second outer electrode 22 is formed so as to cover the deepest portion 12a1 of the second depression 12a and the crest 12b1 of the second annular protrusion 12b.

It is preferable that the second end surface have the second annular protrusion protruding annularly and that the second annular protrusion overlap the circling-shape portions of the coil in transparent view of the multilayer body in the longitudinal direction L. In this case, it is preferable that the second outer electrode cover at least part of the crest of the second annular protrusion in the second end surface. In this case, it is preferable that the thickness of the portion of the second outer electrode covering the deepest portion of the second depression be larger than the thickness of the portion of the second outer electrode covering at least part of the crest of the second annular protrusion.

It is preferable that the depth d₂ of the deepest portion 12a1 of the second depression 12a be 30 μm or more and 50 μm or less (i.e., from 30 μm to 50 μm).

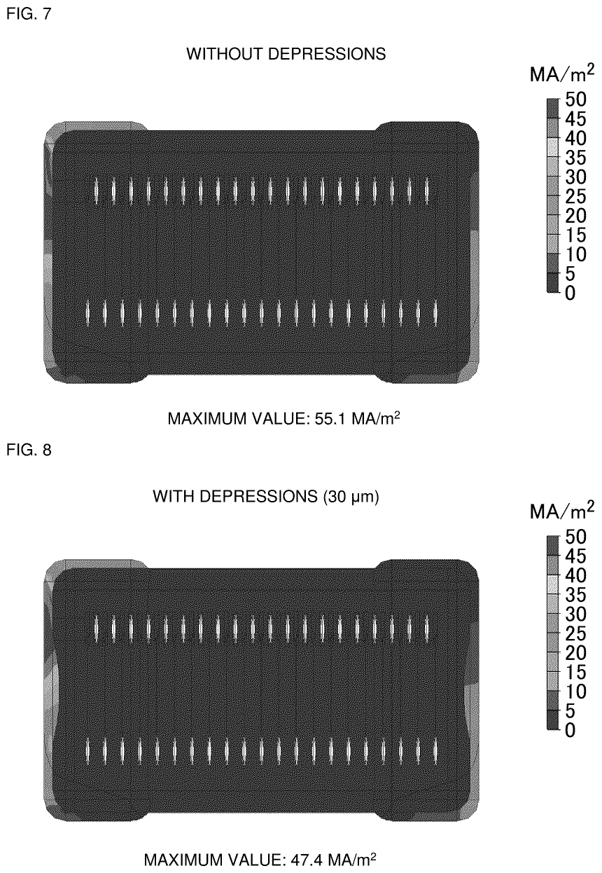

FIG. 7 is a diagram illustrating the simulation results of the current density of the outer electrodes for the case in which each of the first end surface and the second end surface has a depression, and FIG. 8 is a diagram illustrating the simulation results of the current density of the outer electrodes for the case in which each of the first end surface and the second end surface does not have a depression.

In the simulation illustrated in FIG. 7, a laminated coil component of 2012 size (L×W×T=2.0 mm×1.25 mm×1.25 mm) was used. Each of the first end surface and the second end surface of the multilayer body had a depression with a depth of 30 μm at the deepest portion (a first depression and a second depression), and the thickness of the outer electrodes was set to 40 μm. The maximum thickness of the portion of the first outer electrode covering the deepest portion of the first depression was set to 70 μm, and the thickness of the portion of the first outer electrode covering the portions other than the first depression of the first end surface was set to 40 μm. The maximum thickness of the portion of the second outer electrode covering the deepest portion of the second depression was set to 70 μm, and the thickness of the portion of the second outer electrode covering the portions other than the second depression of the second end surface was set to 40 μm.

In the simulation illustrated in FIG. 8, the shape of the multilayer body is changed from the shape in FIG. 7 to a shape without the first depression and the second depression. Specifically, the first end surface and the second end surface of the multilayer body do not have a first depression and a second depression, and hence the first end surface and the second end surface are flat. The thickness of the first outer electrode covering the first end surface and the second outer electrode covering the second end surface was set to 40 μm at all places.

The maximum value of the current density was 55.1 MA/m² in FIG. 8, and it was found that the maximum value of the current density was able to be reduced to 47.4 MA/m² in FIG. 6. The above results show that the laminated coil component of the present disclosure reduces the current density without changing the outer appearance shape conspicuously.

The following describes an example of a method of manufacturing a laminated coil component of the present disclosure.

### Step of Preparing Magnetic Material

First, Fe₂O₃, ZnO, CuO, and NiO are weighed out to have a specified ratio.

Next, these weighed materials, pure water, and the like are placed together with partially stabilized zirconia (PSZ) media into a ball mill, mixed, and then pulverized. Mixing and pulverizing time is set to, for example, 4 hours or more and 8 hours or less (i.e., from 4 hours to 8 hours).

Then, the resultant pulverized material is dried and pre-sintered. The pre-sintering temperature is set to, for example, 700° C. or higher and 800° C. or lower (i.e., from 700° C. to 800° C.). The pre-sintering time is set to, for example, 2 hours or more and 5 hours or less (i.e., from 2 hours to 5 hours).

Thus, a powdery magnetic material, more specifically, a powdery magnetic ferrite material is prepared.

It is preferable that the ferrite material be a Ni—Cu—Zn ferrite material.

As for the Ni—Cu—Zn ferrite material, when the total amount is assumed to be 100 mol %, it is preferable that the Fe₂O₃ content for Fe be 40 mol % or more and 49.5 mol % or less (i.e., from 40 mol % to 49.5 mol %), the ZnO content for Zn be 2 mol % or more and 35 mol % or less (i.e., from 2 mol % to 35 mol %), the CuO content for Cu be 6 mol % or more and 13 mol % or less (i.e., from 6 mol % to 13 mol %), and the NiO content for Ni be 10 mol % or more and 45 mol % or less (i.e., from 10 mol % to 45 mol %).

The Ni—Cu—Zn ferrite material may further contain an additive such as Co, Bi, Sn, and Mn.

The Ni—Cu—Zn ferrite material may further contain inevitable impurities.

### Step of Producing Ceramic Green Sheets

First, a magnetic material, an organic binder such as a polyvinyl butyral based resin, an organic solvent such as ethanol or toluene, a plasticizer, and the like are placed together with PSZ media into a ball mill, mixed, and then pulverized to prepare a slurry.

Next, the slurry is formed into a sheet with a specified thickness by a doctor blade process or the like and then punched into a specified shape to produce ceramic green sheets. The thickness of the ceramic green sheets is set to, for example, 20 μm or more and 30 μm or less (i.e., from 20 μm to 30 μm). The shape of the ceramic green sheet is, for example, rectangular.

The material of the ceramic green sheets may be a non-magnetic material such as a borosilicate glass material instead of a magnetic material or may be a mixed material containing a magnetic material and a non-magnetic material.

### Step of Forming Conductor Patterns

First, via holes are formed by irradiating a specified point on the ceramic green sheets with a laser.

Next, a conductive paste such as a Ag paste is applied to surfaces of the ceramic green sheets by a screen printing or the like while filling the via holes. With this step, conductor portions for via conductors are formed in the via holes in the ceramic green sheets, and conductor patterns for coil conductors connected to the conductor portions for the via conductors are formed on surfaces of the ceramic green sheets. Thus, coil sheets, which are ceramic green sheets having conductor patterns for coil conductors and conductor portions for via conductors, are produced. On the coil sheets, conductor patterns for coil conductors corresponding to the coil conductors 32 illustrated in FIG. 2 and conductor portions for via conductors corresponding to the via conductors 33 illustrated in FIG. 2 (excluding the via conductors 33e and 33f) are formed. Separately from the coil sheets, via sheets having conductor portions for via conductors corresponding to the via conductors 33e and 33f illustrated in FIG. 2 are produced.

### Step of Producing Multilayer Body Block

Coil sheets and via sheets are stacked in the order illustrated in FIG. 2 in the lamination direction (the longitudinal direction L) and then thermal-pressure-bonded to produce a multilayer body block. In this process, thermal pressure bonding is performed by a method in which a first depression and a second depression are formed in the surfaces serving as the first end surface and the second end surface, respectively, of the multilayer body.

The method in which the first depression is formed in the surface serving as the first end surface of the multilayer body is not particularly limited. Examples of the method includes forming a protrusion corresponding to the first depression in the surface of the press die that is used in thermal pressure bonding performed after coil sheets and via sheets are stacked to produce stacked sheets and that comes into contact with the upper surface of the stacked sheets. Similarly, the method in which the second depression is formed in the surface serving as the second end surface of the multilayer body is not particularly limited. Examples of the method includes forming a protrusion corresponding to the second depression in the surface of a base (a press die) that is used in the thermal pressure bonding performed after coil sheets and via sheets are stacked to produce stacked sheets and that comes into contact with the bottom surface of the stacked sheets.

Thus, by forming a protrusion on each of the surfaces of the press die and the base (a press die) that come into contact with the upper surface and the bottom surface, respectively, of stacked sheets in thermal pressure bonding of the stacked sheets, it is possible to manufacture multilayer bodies with the first depression and the second depression formed in the first end surface and the second end surface, respectively.

Since the first end surface and the second end surface of the multilayer body are opposed to each other in the lamination direction of the insulation layers as illustrated in FIG. 2, the shape of the surface of the press die that comes into contact with the upper surface or the bottom surface of stacked sheets in thermal pressure bonding of the stacked sheets is reflected on the shape of the first end surface of the multilayer body.

The position and depth of the first depression and the position and depth of the second depression can be adjusted as appropriate by the shapes of the protrusions formed on the surfaces of the dies. Although the press dies themselves may have the shapes including the protrusions mentioned above, a method in which press dies having flat pressing surfaces are used, and members having shapes corresponding to the aforementioned protrusions may be inserted between the press dies and stacked sheets in pressing the stacked sheets is also possible.

In addition to the method mentioned above in which press dies are used, a method in which the thickness of via sheets and coil sheets and the number of laminated sheets are adjusted and a method in which the conditions for thermal pressure bonding are changed can form a first depression in the first end surface of the multilayer body under some conditions.

### Step of Producing Multilayer Body and Coil

First, a multilayer body block is cut into pieces with a specified size by using a dicer or the like to produce individual chips.

Next, individual chips are sintered. The sintering temperature is set to, for example, 900° C. or higher and 920° C. or lower (i.e., from 900° C. to 920° C.). The sintering time is set to, for example, 2 hours or more and 4 hours or less (i.e., from 2 hours to 4 hours).

When the individual chips are sintered, ceramic green sheets for coil sheets and via sheets turn to insulation layers.

In addition, when individual chips are sintered, conductor patterns for coil conductors and conductor portions for via conductors turn to coil conductors and via conductors, respectively. The process described above produces a coil composed of a plurality of coil conductors laminated together with insulation layers and electrically connected to one another with the via conductors interposed therebetween.

The process above produces a multilayer body including a plurality of insulation layers laminated in the lamination direction and including a coil inside.

The multilayer bodies may be, for example, barrel polished to make the corners and the ridge lines rounded.

### Step of Forming Outer Electrodes

First, a conductive paste such as a paste containing Ag and glass frit is applied to the first end surface and the second end surface to which the coil is extended, out of the outer surfaces of the multilayer body, to form conductive paste layers. For the method of applying a conductive paste, publicly-known conventional methods, for example, a dip method, a method in which a conductive paste is applied by using a brush, and the like, can be used.

Next, the conductive paste layers are baked to form base electrodes for outer electrodes. The baking temperature is set to, for example, 800° C. or higher and 820° C. or lower (i.e., from 800° C. to 820° C.). The thickness of the base electrodes is set to, for example, 5 μm.

Next, a Ni-plated electrode and a Sn-plated electrode are formed in this order on the surfaces of the base electrodes by electrolytic plating or the like. This process forms the outer electrodes each including a base electrode, a Ni plated electrode, and a Sn plated electrode in this order.

Since the first end surface and the second end surface of the multilayer body produced by the procedure described above have a first depression and a second depression, respectively, the laminated coil component of the present disclosure is manufactured by forming the first outer electrode and the second outer electrode so as to cover the first depression and the second depression.

The present specification describes the following items.

The disclosure (1) is a laminated coil component including a multilayer body including a plurality of laminated insulation layers and including a coil inside; and first and second outer electrodes electrically connected to the coil. The coil is composed of a plurality of coil conductors laminated together with the insulation layers and electrically connected to one another. The multilayer body has a first end surface and a second end surface opposed to each other in a longitudinal direction, a first main surface and a second main surface opposed to each other in a height direction orthogonal to the longitudinal direction, and a first side surface and a second side surface opposed to each other in a width direction orthogonal to the longitudinal direction and the height direction. The first outer electrode covers at least part of the first end surface. The second outer electrode covers at least part of the second end surface. A coil axis of the coil is parallel to the first main surface. The first end surface has a first depression having a deepest portion on an inner side of circling-shape portions of the coil in transparent view of the multilayer body in the longitudinal direction, and the first outer electrode covers at least part of the first depression.

The disclosure (2) is the laminated coil component according to the disclosure (1), in which the depth of the deepest portion of the first depression is 30 μm or more and 50 μm or less (i.e., from 30 μm to 50 μm).

The disclosure (3) is the laminated coil component according to the disclosure (1) or (2), in which the maximum thickness of the first outer electrode is larger than the depth of the deepest portion of the first depression.

The disclosure (4) is a laminated coil component combined with any one of the disclosures (1) to (3), in which the first outer electrode covers the deepest portion of the first depression.

The disclosure (5) is the laminated coil component according to the disclosure (4), in which the first end surface has a first annular protrusion protruding annularly, and the first annular protrusion overlaps the circling-shape portions of the coil in transparent view of the multilayer body in the longitudinal direction. Also, the first outer electrode covers at least part of a crest of the first annular protrusion in the first end surface, and the thickness of a portion of the first outer electrode covering the deepest portion of the first depression is larger than the thickness of a portion of the first outer electrode covering the at least part of the crest of the first annular protrusion.

The disclosure (6) is a laminated coil component combined with any one of the disclosures (1) to (5), in which the second end surface has a second depression having a deepest portion on the inner side of the circling-shape portions of the coil in transparent view of the multilayer body in the longitudinal direction, and the second outer electrode covers at least part of the second depression.

What is claimed is:

1. A laminated coil component comprising:
a multilayer body including a plurality of laminated insulation layers and including a coil inside; and
first and second outer electrodes electrically connected to the coil, wherein
the coil includes a plurality of coil conductors which are laminated together with the insulation layers and are electrically connected to each other,
the multilayer body has a first end surface and a second end surface opposed to each other in a longitudinal direction, a first main surface and a second main surface opposed to each other in a height direction orthogonal to the longitudinal direction, and a first side surface and a second side surface opposed to each other in a width direction orthogonal to the longitudinal direction and the height direction,
the first outer electrode covers at least a portion of the first end surface,
the second outer electrode covers at least a portion of the second end surface,
a coil axis of the coil is parallel to the first main surface,
the first end surface has a first depression having a deepest portion on an inner side of circling-shape portions of the coil in transparent view of the multilayer body in the longitudinal direction, and
the first outer electrode covers at least a portion of the first depression.

2. The laminated coil component according to claim 1, wherein
a depth of the deepest portion of the first depression is from 30 μm to 50 μm.

3. The laminated coil component according to claim 1, wherein
a maximum thickness of the first outer electrode is larger than a depth of the deepest portion of the first depression.

4. The laminated coil component according to claim 1, wherein
the first outer electrode covers the deepest portion of the first depression.

5. The laminated coil component according to claim 4, wherein
the first end surface has a first annular protrusion protruding annularly,
the first annular protrusion overlaps the circling-shape portions of the coil in transparent view of the multilayer body in the longitudinal direction,
the first outer electrode covers at least a portion of a crest of the first annular protrusion in the first end surface, and
a thickness of a portion of the first outer electrode covering the deepest portion of the first depression is larger than a thickness of a portion of the first outer electrode covering the at least the portion of the crest of the first annular protrusion.

6. The laminated coil component according to claim 1, wherein
the second end surface has a second depression having a deepest portion on the inner side of the circling-shape portions of the coil in transparent view of the multilayer body in the longitudinal direction, and
the second outer electrode covers at least a portion of the second depression.

7. The laminated coil component according to claim 2, wherein
a maximum thickness of the first outer electrode is larger than a depth of the deepest portion of the first depression.

8. The laminated coil component according to claim 2, wherein
the first outer electrode covers the deepest portion of the first depression.

9. The laminated coil component according to claim 8, wherein
the first end surface has a first annular protrusion protruding annularly,
the first annular protrusion overlaps the circling-shape portions of the coil in transparent view of the multilayer body in the longitudinal direction,
the first outer electrode covers at least a portion of a crest of the first annular protrusion in the first end surface, and
a thickness of a portion of the first outer electrode covering the deepest portion of the first depression is larger than a thickness of a portion of the first outer electrode covering the at least the portion of the crest of the first annular protrusion.
